(19) United States
(12) Patent Application Publication
(10) Pub. No.: US 2026/0249519 A1
(43) Pub. Date: Aug. 27, 2026

(54) RECYCLING OF SELF-SEALING TYRES

(71) Applicants: DOW GLOBAL TECHNOLOGIES LLC, Midland, MI (US); DOW SILICONES CORPORATION, Midland, MI (US)

(72) Inventors: Liangkai MA, Midland, MI (US); Timothy MORLEY, Midland, MI (US); Kyle ATKINS, Midland, MI (US); Frederic GUBBELS, Seneffe (BE); Joel CERVA, Midland, MI (US); Francois DE BUYL, Seneffe (BE); Thomas DAVIDIAN, Seneffe (BE)

(21) Appl. No.: 19/120,901

(22) PCT Filed: Oct. 11, 2023
(86) PCT No.: PCT/US2023/034873

§ 371 Date: Apr. 14, 2025

Related U.S. Application Data
(60) Provisional application No. 63/415,998, filed on Oct. 14, 2022.

(51) Int. Cl. B29B 17/02; B09B 3/35; B09B 101/80; B29B 17/04; B29K 21/00; B29K 83/00; B29L 30/00

(52) U.S. Cl. CPC B29B 17/02; B09B 3/35; B29B 17/0412; B09B 2101/80; B29B 2017/0203; B29B 2017/0217; B29K 2021/00; B29K 2083/00; B29L 2030/00

(57) ABSTRACT

The present disclosure generally relates to a method for recycling self-sealing tyres and the products resulting from the recycling process. The tyres in question comprise a tyre body having an inner surface and an outer surface and a puncture-resistant layer applied on the inner surface, wherein the puncture-resistant layer is a layer of a condensation cured self-sealing silicone sealant.

The present disclosure generally relates to a method for recycling self-sealing tyres and the products resulting from the recycling process. The tyres in question comprise a tyre body having an inner surface and an outer surface and a puncture-resistant layer applied on the inner surface, wherein the puncture-resistant layer is a layer of a condensation cured self-sealing silicone sealant.

Globally it is believed over a billion vehicle tyres come to the end of their functional life each year and need to be disposed of. They are referred to as “end of life tyres” or ELTs as they are deemed to be no longer able to serve their intended purpose on a vehicle. In many countries a large proportion of ELTs end up in landfill which is a significant problem because they both take up a large amount of landfill space and have a significantly negative environmental impact on the surrounding area. If left such tyres will decompose very slowly releasing harmful chemicals into the surrounding environment and obviously are not aesthetically pleasing, especially if left in huge piles. They can catch fire in which case clouds of toxic fumes incorporating carcinogens and mutagens and other toxins such as butadiene and/or styrene combustion products as well as dioxins, furans, cyanides, carbon monoxide and/or sulphur dioxide can be released. Furthermore, in some cases heavy metals such as lead, mercury and or chromium (VI) can also be released from burning tyres. To complicate matters further modern-day tyres are not made solely from rubber(s) but tyre components such as treads, belt packages, carcass layers and side walls can incorporate fibres, textiles and particularly steel wires as means of reinforcement.

A variety of methods for recycling tyres have been proposed. In many or most of these the first step is the removal of steel wires when present. After this the tyre may undergo a wide range of processes including, for the sake of example, various tyre shredding and grinding processes have been proposed, cryogenic crushing (where tyres are frozen to a temperature of about −50 to −80° C. to render the rubber brittle so that they can be crushed); pyrolysis i.e. the thermal degradation of the organic components of the tyres, typically at pyrolysis temperatures of up to and around e.g. 500° C. to produce an oil, gas and char product in addition to the recovery of the steel (if not removed prior to pyrolysis) as well as other processes including, for example, the process described in U.S. Pat. No. 6,722,593. Of these probably the shredding and grinding processes are the cheapest and most commonly utilised. However, the introduction of self-sealing tyres (SSTs) has created issues for such processes. Self-sealing tyres (SSTs) have been introduced to allow a vehicle to continue to travel by preventing the loss of pressure in one or more tyres after a puncture. This makes it possible, for example, to drive to a breakdown point without having to stop, often in hazardous circumstances, to fit a spare tyre. Self-sealing tyre (SST) technology has become an increasingly important route to achieve safe and sustainable mobility. SSTs contain an inner layer of a self-sealing material e.g., a sealant which by definition is capable of automatically ensuring that a tyre is sealed in the event of a puncture thereof by a foreign body, such as a nail.

To be usable, a self-sealing layer made upon cure from a suitable self-sealing composition must be effective over a very wide range of operating temperatures and to do so over the entire lifetime of the tyre. It must be capable of closing off holes when the responsible puncturing object, which we call a “nail”, remains in place. Upon expelling the nail, the self-sealing layer must be able to fill up the hole and make the tyre airtight, especially under winter conditions. Many SSTs use sealants such as butyl rubber sealants to seal the puncture. It has been found that, when seeking to recycle SSTs such butyl sealants can't be removed from an ELT because they are too strongly chemically bound to the tyre inner surface on which they were applied as a puncture-resistant layer, given they cured via a radical process which causes chemical interactions between the butyl rubber sealant and the tyre surface. Current recycling processes of SSTs coated with butyl/synthetic rubber blend sealants as puncture-resistant layers cause troublesome problems such as “gumming up” shredders and sticking to conveyors used during separation process due to the highly tacky butyl/synthetic rubber coating especially at elevated temperatures generated during shredding.

Hence, as the sales of self-sealing tyres grow there is a consequential increase in scrap SSTs and therefore an increasing need to recycle them more efficiently as opposed to having to send them to landfill.

In the present disclosure there is provided a method of recycling one or more self-sealing tyres, the or each self-sealing tyre having a tyre body made of flexible and airtight material and optionally containing one or more reinforcing wires, reinforcing fibres or both made from one or more of metals, polymers, and/or glass, said tyre body having an inner surface and an outer surface and a puncture-resistant layer applied on the inner surface, wherein the puncture-resistant layer is a layer of a suitable condensation cured self-sealing silicone sealant, comprising the steps of:
ai) removing the layer of condensation cured self-sealing silicone sealant by scraping it off the inner surface of the tyre body with a suitable scraper or
aii) making a cut in the layer of condensation cured self-sealing silicone sealant, to form a first and second end thereof, attaching the first end of condensation cured self-sealing silicone sealant to a roller and peeling said condensation cured self-sealing silicone sealant from the inner surface of the tyre body;
b) optionally removing reinforcing wires, reinforcing fibres or both made from one or more of metals, polymers, and/or glass from the tyre body;
c) recycling the tyre body resulting from step (ai), step (aii) or step (b) by shredding, grinding, cryogenic crushing, pyrolysis, and/or microwave techniques;
d) recycling or reusing the condensation cured self-sealing silicone sealant removed in step (ai) or (aii).

Butyl rubber-based materials are believed to be the most commonly used as the puncture-resistant layer applied on the inner surface of the tyre body in SSTs. Such butyl rubber-based sealants which are cured/vulcanized onto the inner surface of the tyre body using a radical curing process, which imparts a chemical bonding between the butyl rubber and the rubber of the tyre body. The use of a suitable condensation cured self-sealing silicone sealant as the puncture-resistant layer applied on the inner surface of the tyre body in SST imparts a good physical adhesion to the rubber but is not chemically bound. A condensation cured self-sealing silicone sealant does not induce any form of chemical bonding reaction with the rubber of the tyre body. Suitable condensation cured silicone sealants do however exhibit a suitably high tackiness e.g., they are very sticky/tacky to the touch after application to a tyre body inner surface as a silicone puncture-resistant layer. The condensation cured silicone sealants exhibit good wetting properties and excellent physical adhesion to the rubber.

It has been identified that despite its tackiness the condensation cured silicone sealant can be separated from the inner surface of the tyre body by either
ai) removing the layer of condensation cured self-sealing silicone sealant by scraping it off the inner surface of the tyre body with a suitable scraper or
aii) making a cut in the layer of condensation cured self-sealing silicone sealant, to form a first and second end thereof, attaching the first end of condensation cured self-sealing silicone sealant to a roller and peeling said condensation cured self-sealing silicone sealant from the inner surface of the tyre body.

Because butyl rubber is chemically bound to the rubber of the tyre body, it is non-separable from the tyre body and as such, in many cases, SSTs having butyl rubber-based puncture-resistant layers can't utilise several of the recycling processes used with ELTs. However, condensation cured silicone sealants described herein, because they are physically and not chemically bound to the tyre, can be effectively and efficiently removed prior to recycling of the SSTs tyre body. Once the puncture-resistant layer of condensation cured silicone sealant has been removed the tyre body of SSTs can be recycled in the same way as conventional (non-SST) tyres e.g., by using, for example, mechanical shredding operations or other tyre recycling techniques, thus rendering issues such as tyres pre-sorting and shredder “gumming up” can be avoided, enabling to be recycled as simply as standard non-SST tyres.

In one embodiment the puncture-resistant layer of condensation cured self-sealing silicone sealant is removed from the SST at a temperature of from room temperature (i.e., between 20° C. and 25° C.) to about 70° C. It was found that whilst it can be removed adequately well at room temperature in some instances an elevated temperature might be preferred. If desired the SST may be heated or cooled to a selected temperature to assist in the removal of the condensation cured self-sealing silicone sealant. In a further embodiment the condensation cured self-sealing silicone sealant may be treated with a solvent to assist in the removal thereof from the inner face of the rubber body. Any suitable solvent may be selected from unreactive short-chain siloxanes or suitable organic solvents which are able to swell the sealant matrix.

In the case of step ai), the layer of condensation cured self-sealing silicone sealant may be removed by scraping it off the inner surface of the tyre body with a suitable scraper. The scraper may be provided with a nonstick coating or a lubricant applied on its surfaces to facilitate the silicone sealant removal especially when seeking to remove “sticky” silicone sealants. Examples of nonstick coatings and/or lubricants may include, for the sake of example, polytetrafluoroethylene (PTFE), organic based lubricants and/or siloxanes or even water.

The removed condensation cured silicone sealant which had comprised the puncture-resistant layer of the SST may be collected in any suitable manner, for example, the scraper for scraping off the condensation cured silicone sealant from the tyre body may be utilised in combination with a suitably positioned rotating roller or mandrel for continuously collecting the removed sealant or may be used in combination with a suitable vacuum device designed to collect the removed sealant in lieu of the roller.

### Process Step (ai) Scraping

Hence, step ai) may be sub-divided into the following process steps:
a) Place a self-sealing tyre containing a puncture-resistant layer of condensation cured self-sealing silicone sealant on a support which allows a tyre and scraper to be rotated relative to each other;
b) Precut the condensation cured self-sealing silicone sealant across the whole or part of the width of the inner surface of the tyre using a scraper or knife to provide a first cut end in the sealant and a second cut end in the sealant and position the scraper between the first cut end and the second cut end in the sealant;
c) initiate scraping by inserting the scraper between the first cut end in the sealant and the tyre body inner surface, with the scraper positioned at a suitable scraping angle relative to the tyre body inner surface to cause an initial separation of condensation cured self-sealing silicone sealant from the tyre body inner surface and initiating operation of a means for collecting condensation cured self-sealing silicone sealant as it becomes separated from the inner surface of the tyre body;
d) either rotate the tyre relative to the scraper being in a fixed position or rotate the scraper around the inner surface of the tyre body when the tyre is in a fixed position to continuously separate the condensation cured self-sealing silicone sealant from the inner surface of the tyre body and collecting the sealant as it is removed;
e) in the case where only part of the width of the layer of sealant on the inner surface of the tyre was cut and removed in steps b), c) and d), repeat said steps b), c) and d) for one or more further parts until sealant has been totally removed;
f) Once the sealant is removed from the SST to leave a substantially sealant-free tyre body, remove the tyre body from the support and the collected condensation cured self-sealing silicone sealant for further processing in accordance with the process above.

The scraping angle is defined as the angle between the surface on the tyle substrate from which the sealant is being removed and the plane of the scraper blade.

In one alternative the support may be a tyre spreader or the like enabling the scraper to be locked into a position at a desired fixed scraping angle relative to the inner surface of the tyre body and the tyre can be rotated relative to the fixed scraper. The scraping angle for the scraping process may be between 5° and about 80° to the horizontal, alternatively between 10° and about 70° to the horizontal, alternatively from 20° 50° to the horizontal. Any suitable tyre spreader may be utilised for this purpose, for example a 5700 Tyre Spreader from Branick Industries Inc. of North Dakota USA together with a suitable motor or actuator for rotating the SST while sealant is being removed by scraping (or peeling in the case of (aii).

Preferably, on average a minimum of 80% by weight of the sealant is removed from the inner surface of the tyre, preferably in a single operation i.e., after one complete rotation of the whole tyre.

Whilst the intention is that the sealant is completely removed it is possible that the separation process may leave very small amounts of sealant adhered to the inner surface of the tyre body.

Alternatively, on average a minimum of 90% by weight of the sealant is removed from the inner surface of the tyre, preferably in a single operation i.e., after one complete rotation of the whole tyre. on average a minimum of 95% by weight of the sealant is removed from the inner surface of the tyre, preferably in a single operation i.e., after one complete rotation of the whole tyre. Most preferably sealant is completely removed.

Any suitable scraper may be used. For example, the scraper may be manually operated or if desired, especially in situations where the sealant being separated from the SST is considered more difficult to remove (e.g., more sticky or tacky) the scraper may be operated using a vibratory or oscillating mechanism in the scraper to facilitate the silicone sealant removal. Such scrapers may be electrically, pneumatically hydraulically or acoustically (ultrasonically) or the like driven to introduce such additional vibration or oscillation during the removal process to render the sealant more easily separated from the inner surface of the tyre body.

The means for collecting condensation cured self-sealing silicone sealant may be a roller or mandrel or screw or may be a vacuum system. In the case of a roller or mandrel these may also be rotated when collecting said sealant. In one embodiment the sealant may be continuously removed from the inner surface of the tyre body using a scraper on the roller/mandrel/screw with the separated sealant being accumulated on the roller/mandrel/screw. Indeed, the adhesiveness of the condensation cured self-sealing silicone sealant enables newly collected sealant having been separated from the inner surface of the tyre body to stick to the already collected sealant at the interfacial surfaces, to simplify the collecting operation, particularly when relying on the aforementioned roller/mandrel/screw.

In one embodiment the roller, mandrel or screw utilised to collect the separated condensation cured self-sealing silicone sealant may be used after sealant removal, to transfer the collected sealant from the SST into a suitable receptacle such as a drum or skip in preparation for further recycling steps.

The scraper on the tyre may be removed or repositioned on the collector drum during such a stage.

Alternatively, the roller/mandrel full of sealants may be removed for storage and replaced with a new roller/mandrel.

In a further alternative the collected sealant may be moved onto a continuously rolling transport belt/band/line for automatic and continuously sealant removal operation with the sealant collecting system removing the sealant as soon as the scraper initiates the cut and scraping off the sealant from a tyre.

### Process Steps by Peeling (Aii)

Step aii) is probably most suited when the condensation cured self-sealing silicone sealant is not as sticky/tacky to the touch and/or which has a larger tensile strength to allow smooth peeling without tensile breakage of the sealant during peeling, as the scraper is not utilised and the condensation cured self-sealing silicone sealant being removed is merely peeled away from the inner surface of the tyre body onto a suitable roller/mandrel/screw without need of the scraper. Optionally however, an element such as a second roller or a plate for controlling the peeling angle may be utilised in the peeling configuration between the SST inner surface and the roller mandrel/screw utilised to collect the removed sealant. Otherwise, the sealant collecting roller or mandrel or screw can function as a peeling angle control element as well as sealant collecting element. The peeling angle is defined as the angle between the surface on the tyre substrate from which the sealant is being removed and the plane of the sealant being transferred to the roller subsequent to peeling.

Hence when using the peeling process (aii) the process may be as follows:

Step aii) may be sub-divided into the following process steps:
a) Place a self-sealing tyre containing a puncture-resistant layer of condensation cured self-sealing silicone sealant on a support which allows a tyre to be rotated;
b) Precut the condensation cured self-sealing silicone sealant across the whole tyre width using a scraper or knife to provide a first cut end in the sealant and a second cut end in the sealant and connect the first cut end to a roller/mandrel/screw designed to collect the condensation cured self-sealing silicone sealant subsequent to having been peeled from the inner surface of the tyre body;
c) initiate peeling of the condensation cured self-sealing silicone sealant from the inner surface of the tyre body by rotating the tyre relative to the roller/mandrel/screw enabling the peeled sealant to be collected on the roller/mandrel/screw with the roller/mandrel/screw positioned at a suitable peeling angle and distance from the sealant being peeled from the inner surface of the tyre body.
d) rotate the tyre relative to the roller/mandrel/screw at a desired peeling angle controlling roller to adjust the peeling angle in a desired range (typically an acute angle, i.e., an angle of less than 90°) thereby continuously peeling the condensation cured self-sealing silicone sealant from the inner surface of the tyre body and collecting the sealant as it is removed while simultaneously rotating the sealant collecting roller/mandrel/screw to continuously peel and collect the removed sealant.
e) Once the sealant is removed from the SST to leave a substantially sealant-free tyre body, remove the tyre body from the support and the collected condensation cured self-sealing silicone sealant for further processing in accordance with the process above.

In alternative (aii) a second roller may be utilised as a means of controlling the peeling angle. The peeling angle as previously defined for the peeling process may also be between 5° and about 80°, alternatively between 10° and about 70°, alternatively from 20° to about 50⁰.

Preferably when simultaneously rotating the sealant collecting roller/mandrel/screw is driven electrically, pneumatically or by other power sources. Preferably the rotation speed of the tyre and either roller or mandrel or screw when selected, may be automatically adjusted and/or controlled to prevent breakage of the peeled off condensation cured self-sealing silicone sealant based on the tensile strength of the sealant.

In one embodiment a sensor such as a torque sensor or load cell may be utilised to detect the force tangential to the circumference of the roller or the like and to control/adjust roller or the like speeds to prevent breakage of the sealant being removed from the tyre.

If desired a vibration mechanism such as an air-scraper may be incorporated on the roller that induces some oscillation in the peel angle to help peeling the condensation cured self-sealing silicone sealant from the inner surface of the tyre body.

Furthermore, if desired the or each roller or the like may be designed to move from a sharp angle to a less sharp peeling angle as and when desired in order to improve efficiency of the system.

Alternatively, or each roller or the like may be designed to move back and forth in the direction of the collected product in order to induce extension forces that improve efficiency of collected product.

Irrespective of whether alternative (ai) or (aii) is utilised, once the sealant is removed from the whole tyre, the remaining tyre body is removed and replaced by another SST and the process is repeated.

Typically, the remaining tyre bodies are recycled in a standard manner subsequent to having the condensation cured self-sealing silicone sealant removed therefrom.

Typically step (b) as hereinbefore described is the next step in the process for recycling the tyre body, in that reinforcing materials, particularly reinforcing wires, reinforcing fibres or both made from one or more of metals, polymers, and/or glass are removed from the body. This is most often the removal of steel wires if required. This step is deemed optional dependent on whether or not they need to be removed in view of the subsequent processes being undertaken. Steel wires may be extracted using suitable metal wire separators or the like which are industrially available and well known in the art.

Once the reinforcing materials are removed, if required the remaining rubber from the tyre body can be recycled via any suitable process such as shredding, grinding, milling, pulverizing, cryogenic processing and pyrolysis. Any of these processes can be used to reduce the size of the pieces of residual rubber and these can then be further processed or regulated using granulators and screens and the like. The other main way of reducing the size of the residual rubber is via a cryogenic process whereby the tyre bodies, with the sealant removed are frozen, usually utilising liquid nitrogen and then crushed whilst frozen using a suitable apparatus such as a hammer crusher/or hammer mill. Typically, when using this cryogenic process, it is less important to first remove the reinforcing materials, especially steel wires as the steel wires can be extracted using magnets after crushing if preferred. Other materials and detritus may be extracted by either screening processes or via an air classifier or the like which is able to separate materials by ca combination or size, shape and/or density. Resulting rubber pieces/particles may subsequently be cleaned and utilised as a product or further processed. If desired the shredded or cryogenically smashed rubber pieces may be further treated using one or more chemical processes.

In a further alternative, whole or shredded or cryogenically smashed tyres may be pyrolised to provide fuel oil, char products such as carbon black and or solid fuels and gaseous products such as hydrogen, short chain hydrocarbons having from 1 to 6 carbons (usually 1 to 4 carbons), carbon dioxide and carbon monoxide. Typically, in tyre pyrolysis the tyre bodies or broken-down rubber pieces undergo thermal degradation at temperatures in the range of 500° C.

The condensation cured self-sealing silicone sealant may be reused or may be recycled for example by the chemical recycling using depolymerization to produce low molecular weight oligomers which can be utilised in the preparation of siloxane polymers or may alternatively also undergo both pyrolysis and/or mechanical recycling. A further route for recycling shredded tire materials of construction without removing the steel band or wires is via the use of these materials in the Portland cement manufacturing process as described in the paper published as Recycling of waste tire rubber in asphalt and Portland cement concrete: An overview in Construction and Building Materials Vol. 67, Part B, 30 Sep. 2014, pages 217-224.

To be usable, a self-sealing layer made upon cure of a suitable self-sealing composition must be effective over a very wide range of operating temperatures and to do so over the entire lifetime of the tyre. It must be capable of closing off holes when the responsible puncturing object, which we call a “nail”, remains in place. Upon expelling the nail, the self-sealing layer must be able to fill up the hole and make the tyre airtight, especially under winter conditions. Key properties, namely tensile strength, elongation and cross-link density or the storage modulus have been identified in the industry as particular pertinent for the function of a self-sealing layer.

Tensile strength refers to the maximum stress (force per unit area) that a specimen of a material e.g., the condensation cured self-sealing silicone sealant herein can withstand before rupturing.

Elongation measures the relative increase in length of a specimen of condensation cured self-sealing silicone sealant at the point of rupture. Cross-link density is a molecular property which measures the concentration of cross-links present in that part of the sealant which has been cured into a three-dimensional cross-linked network. The storage modulus of a material is related to the cross-link density of the material. A high crosslink density will lead to a higher storage modulus and conversely a low crosslinked material will exhibit a low storage modulus.

If the tensile strength of a sealant is too low, the sealant will flow under typical tyre operating conditions and will also “blow through” a puncture hole when a puncturing object is removed from the tyre and fail to seal the hole. It has also been determined that when a sealant has such a low tensile strength the peeling process e.g. (aii) is not preferred. An acceptable sealant must therefore be formulated with sufficient tensile strength to withstand such a “blow through”.

If the elongation of a sealant is too low, it will have several defects. When an object such as a nail enters a tyre, whose interior is coated with a self-sealing sealant composition, the resulting sealant should preferably adhere to the nail and form a tent-like structure surrounding it. Adhesion of the sealant to the nail at this time will assist in preserving an air barrier at the puncture and will also result in the sealant being drawn by the nail into the puncture hole as the nail is removed. If the sealant has insufficient elongation, it will be unable to stretch enough to form a tent. The sealant may then “cap” the nail, i.e., a small portion of sealant surrounding the tip of the nail will break away from the remainder of the sealant and remain adhered to the nail near its tip. Capping generally results in poor nail-in sealing performance. A further result of low elongation will be that in the case of a large puncture, not enough sealant will be able to flow over and into the hole to affect a seal when the puncturing object is removed.

The cross-link density of a polymeric sealant determines how strongly the sealant will resist permanent deformation. If the sealant has too high a cross-link density or storage modulus, it will be too resistant to permanent deformation, and the sealant will cap a puncturing object rather than form a tent, with the results described above. If the cross-link density or storage modulus is too low, centrifugal force will cause the sealant to creep or flow at elevated temperatures, resulting in insufficient sealant underlying the shoulder portion of the tyre. Too low a cross-link density of the sealant composition when cured will also result in a low fatigue resistance for the resulting sealant.

Fatigue resistance is an important requirement for an effective tyre sealant, most particularly in the situation where an object such as a nail enters a tyre, and the tyre is then used for a considerable time without the nail being removed. In a typical case, of course, a motorist will not even be aware of the nail's presence. Periodic contact between the punctured portion of the tyre and the road will result in the nail flexing back and forth as the tyre rotates. While the sealant may have formed a seal over or around the nail, the sealant itself will be continually stretched and relaxed, a process which over time will potentially cause the seal to fail and break the air seal.

Generally self-sealing tyre solutions thus far have rarely utilised silicone materials. Until recently, silicone compositions that form the gels and/or elastomers with fast cure speed are based on addition cure chemistry, or hydrosilylation, i.e., they are cured by the reaction of a silicon hydride group with onto an unsaturated carbon radical with the help of a catalyst, which is typically a platinum-based compound.

The condensation cured self-sealing silicone sealant utilised for SSTs may include the cured products of suitable condensation curable self-sealing tyre silicone sealant compositions described in WO2018024857, WO2022108896 (both of which are incorporated herein by reference) and the self-seal tyre sealant SILASTIC™ SST-2650 sealant commercially available from Dow Silicones Corporation.

These may include
a two-part condensation curable self-sealing tyre silicone sealant composition comprising
(i) at least one condensation curable silyl terminated polymer having at least one, typically at least two hydroxyl functional groups per molecule;
(ii) a cross-linker selected from the group of
   silanes having at least 2 hydrolysable groups, alternatively at least 3 hydrolysable groups per molecule group; and/or
   silyl functional molecules having at least 2 silyl groups, each silyl group containing at least one hydrolysable group,
and
(iii) a condensation catalyst selected from the group of titanates and/or zirconates
wherein (i), (ii) and (iii) are not stored together in a single part,
   characterized in that the molar ratio of total silicon bonded hydroxyl (Si—OH) groups to total hydrolysable groups is between 0.5:1 and 3:1 using a silyl containing cross linker or 0.5:1 to 10:1, alternatively 0.5:1 to 4:1 using silyl functional molecules containing crosslinker and the molar ratio of catalyst M-OR functions to the sum of moisture present in the composition, as determined in accordance with ISO 787-2:1981, and total silicon bonded hydroxyl groups is between 0.01:1 and 0.6:1, where M is titanium or zirconium.

It is to be understood that for the sake of this application that “total hydrolysable groups” excludes both moisture and silicon bonded hydroxyl groups present in the composition.

The total silicon bonded hydroxyl (Si—OH) molar content is calculated for 100 g of the mixed formulation. The total silicon bonded hydroxyl molar content related to a polymer is equal to the amount in g of hydroxyl containing polymer in 100 g of the mixed product divided by the number average molecular weight (Mn) of the polymer multiply by the average number of hydroxyl functions present in the polymer, typically 2. If there are several hydroxyl functional polymers in the formulation, the sum of the molar content of each polymer is sum up to constitute the total silicon bonded hydroxyl (Si—OH) molar content in the formulation.

The number average molecular weight (Mn) and weight average molecular weight (Mw) of silicone can also be determined by Gel permeation chromatography (GPC). This technique is a standard technique, and yields values for Mw (weight average), Mn (number average) and polydispersity index (PI) (where PI=Mw/Mn).

Mn values provided in this application have been determined by GPC and represent a typical value of the polymer used. If not provided by GPC, the Mn may also be obtained from calculation based on the dynamic viscosity of said polymer. The catalyst M-OR value is =[(g of Titanate catalyst)*(number of OR in compound)] divided by the (molecular weight of Titanium catalyst).

The condensation curable self-scaling tyre silicone sealant composition described here has a viscosity, when uncured, that permits the condensation curable self-sealing tyre silicone sealant composition to be incorporated into a tyre during a tyre building process and a viscosity that, when cured, permits the condensation cured self-sealing silicone sealant to flow into and seal a puncture in a tyre. In one embodiment when the polymer (i) and cross-linker (ii) are mixed in the same part prior to mixing the viscosity of polymer (i) and cross-linker (ii) at 23° C. is equal or greater than 0,000 mPa·s as measured by a Brookfield cone plate viscometer RV DIII using the most appropriate cone plate for the viscosity of the composition.

Polymer (i) is at least one moisture/condensation curable silyl terminated polymer. Any suitable moisture/condensation curable silyl terminated polymer may be utilised including polydialkyl siloxanes, alkylphenyl siloxane, or organic based polymers with silyl terminal groups e.g., silyl polyethers, silyl acrylates and silyl terminated polyisobutylenes or copolymers of any of the above.

Preferably the polymer is a polysiloxane based polymer containing at least one hydroxyl, most preferably the polymer comprises two terminal hydroxyl groups. Examples of suitable hydroxyl containing groups include —Si(OH)₃, —(R^{a})Si(OH)₂, —(R^{a})₂Si(OH), or —(R^{a})₂Si—R^{c}— SiR^{d}ₚ(OH)₃₋ₚ where each R^{a} independently represents a monovalent hydrocarbyl group, for example, an alkyl group, in particular having from 1 to 8 carbon atoms, (and is preferably methyl); each R^{d} group is independently an alkyl group in which the alkyl groups suitably have up to 6 carbon atoms; R^{c} is a divalent hydrocarbon group having up to 12 carbon atoms which may be interrupted by one or more siloxane spacers having up to six silicon atoms; and p has the value 0, 1 or 2.

Preferably polymer (i) has the general formula

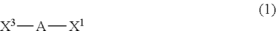

where X³ and X¹ are independently selected from siloxane groups which terminate in hydroxyl containing groups and A is a siloxane and/or organic containing polymeric chain, alternatively a siloxane polymeric chain.

Examples of hydroxyl-terminating groups X³ or X¹ include —Si(OH)₃, —(R^{a})Si(OH)—, —(R^{a})₂Si(OH), or —(R^{a})₂Si—R^{c}—Si(R^{a})ₚ(OH)₃₋ₚ as defined above. Preferably the X³ and/or X¹ terminal groups are hydroxydialkyl silyl groups, e.g., hydroxydimethyl silyl groups.

Examples of suitable siloxane groups in polymeric chain A of formula (I) are those which comprise a polydiorgano-siloxane chain. Thus, polymeric chain A preferably includes siloxane units of formula (2)

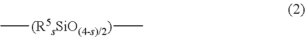

in which each R⁵ is independently an organic group such as a hydrocarbyl group having from 1 to 10 carbon atoms optionally substituted with one or more halogen group such as chlorine or fluorine and s is 0, 1 or 2, typically p is about 2. Particular examples of groups R⁵ include methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group. Suitably, at least some and preferably substantially all of the groups R⁵ are methyl.

Typically, the polymers of the above type will have a viscosity in the order of 1,000 to 300,000 mPa·s, alternatively 1,000 to 100,000 mPa·s at 23° C. measured by using a Brookfield cone plate viscometer (RV DIII) using the most appropriate cone plate for the viscosity concerned.

Preferred polysiloxanes containing units of formula (2) are thus polydiorganosiloxanes having terminal, silicon-bound hydroxyl groups or terminal, silicon-bound organic radicals which can be hydrolysed using moisture as defined above. The polydiorganosiloxanes may be homopolymers or copolymers. Mixtures of different polydiorganosiloxanes having terminal condensable groups are also suitable.

For the purpose of this application “substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

Crosslinkers (ii) that can be used are generally moisture curing
silanes having at least 2 hydrolysable groups, alternatively at least 3 hydrolysable groups per molecule group; and/or
silyl functional molecules having at least 2 silyl groups, each silyl group containing at least one hydrolysable group.

In some instances, the crosslinker (ii) having two hydrolysable groups may be considered a chain extender, i.e., when polymer (i) only has 1 or two reactive groups but can be used to cross-link if polymer (i) has 3 or more reactive groups per molecule. The crosslinker (ii) may thus have two but alternatively has three or four silicon-bonded condensable (preferably hydroxyl and/or hydrolysable) groups per molecule which are reactive with the condensable groups in polymer (i).

For the sake of the disclosure herein silyl functional molecule is a silyl functional molecule containing two or more silyl groups, each silyl group containing at least one hydrolysable group.

Hence, a disilyl functional molecule comprises two silicon atoms each having at least one hydrolysable group, where the silicon atoms are separated by an organic or siloxane spacer.

Typically, the silyl groups on a disilyl functional molecule may be terminal groups. The spacer may be a polymeric chain.

For the sake of the disclosure herein a disilane is a silyl functional molecule having at least 2 silyl groups where the two silicon atoms are bonded to one another.

The hydrolysable groups on the silyl groups include acyloxy groups (for example, acetoxy, octanoyloxy, and benzoyloxy groups); ketoximino groups (for example dimethyl ketoximo, and isobutylketoximino); alkoxy groups (for example methoxy, ethoxy, and propoxy) and alkenyloxy groups (for example isopropenyloxy and 1-ethyl-2-methylvinyloxy). In some instances, the hydrolysable group may include hydroxyl groups.

The silane cross-linker (ii) includes alkoxy functional silanes, oximosilanes, acetoxy silanes, acetonoxime silanes and/or enoxy silanes.

When the crosslinker is a silane and when the silane has three silicon-bonded hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. The fourth silicon-bonded organic groups may be methyl.

A typical silane may be described by formula (3)

R″_{4-c}Si(OR⁵)ᵣ (3)

wherein R⁵ is described above and r has a value of 2, 3 or 4. Typical silanes are those wherein R″ represents methyl, ethyl, vinyl, or isobutyl. R″ is an organic radical selected from linear and branched alkyls, allyls, phenyl and substituted phenyls, acethoxy, oxime. In some instances, R⁵ represents methyl or ethyl and r is 3.

Another type of suitable crosslinkers (ii) are molecules of the type Si(OR⁵)₄ where R⁵ is as described above, alternatively propyl, ethyl or methyl. Partial condensates of Si(OR⁵)₄ may also be considered.

In one embodiment the cross-linker (ii) is a silyl functional molecule having at least 2 silyl groups each having at least 1 and up to 3 hydrolysable groups, alternatively each silyl group has at least 2 hydrolysable groups.

The crosslinker (ii) may be a disilyl functional polymer, that is, a polymer containing two silyl groups, each containing at least one hydrolysable group such as described by the formula (4)

(R⁴O)ₘ(Y¹)₃₋ₘ—Si(CH₂)ₓ—((NHCH₂CH₂)ₜ-Q(CH₂)ₓ)ₙ—Si(OR⁴)ₘ(Y¹)₃₋ₘ (4)

where R⁴ is a C₁₋₁₀ alkyl group, Y¹ is an alkyl groups containing from 1 to 8 carbons, Q is a chemical group containing a heteroatom with a lone pair of electrons e.g., an amine, N-alkylamine or urea; each x is an integer of from 1 to 6, t is 0 or 1; each m is independently 1, 2 or 3 and n is 0 or 1.

The silyl (e.g., disilyl) functional crosslinker (ii) may have a siloxane or organic polymeric backbone. Suitable polymeric crosslinkers (ii) may have a similar polymeric backbone chemical structure to polymeric chain A as depicted in formula (1) above. In the case of such siloxane or organic based cross-linkers the molecular structure can be straight chained, branched, cyclic or macromolecular, i.e., a silicone or organic polymer chain bearing alkoxy functional end groups include polydimethylsiloxanes having at least one trialkoxy terminal where the alkoxy group may be a methoxy or ethoxy group.

In the case of siloxane-based polymers the viscosity of the cross-linker will be within the range of from 0.5 mPa·s to 80,000 mPa·s at 23° C. using a Brookfield cone plate viscometer (RV DIII) utilising a cone plate (measured in the same manner as polymer (i)). Whilst any of the hydrolysable groups mentioned above are suitable it is preferred that the hydrolysable groups are alkoxy groups and as such the terminal silyl groups may have the formula such as —R^{a}Si(OR^{b})₂, —Si(OR^{b})₃, —R^{a}₂SiOR^{b} or —(R^{a})₂Si—R^{c}—SiR^{d}ₚ(OR^{b})₃₋ₚ where each R^{a} independently represents a monovalent hydrocarbyl group, for example, an alkyl group, in particular having from 1 to 8 carbon atoms, (and is preferably methyl); each R^{b} and R^{d} group is independently an alkyl group having up to 6 carbon atoms; R^{c} is a divalent hydrocarbon group which may be interrupted by one or more siloxane spacers having up to six silicon atoms; and p has the value 0, 1 or 2. Typically each terminal silyl group will have 2 or 3 alkoxy groups.

Examples of disilyl polymeric crosslinkers (ii) with a silicone or organic polymer chain bearing alkoxy functional end groups include 1,6-bis (trimethoxysilyl)hexane (alternatively known as hexamethoxydisilylhexane HMSH), polydimethylsiloxanes having at least one trialkoxy terminal where the alkoxy group may be a methoxy or ethoxy group.

Crosslinkers (ii) thus include alkyltrialkoxysilanes such as methyltrimethoxysilane (MTM) and methyltriethoxysilane, tetraethoxysilane, partially condensed tetraethoxysilane, alkenyltrialkoxy silanes such as vinyltrimethoxysilane and vinyltriethoxysilane, isobutyltrimethoxysilane (iBTM).

Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoxiniino)silane, methyltris(isopropenoxy)silane, vinyltris(isopropenoxy)silane, ethylpolysilicate, n-propylorthosilicate, ethylorthosilicate, dimethyltetraacetoxydisiloxane, oximosilanes, acetoxy silanes, acetonoxime silanes, enoxy silanes and other such trifunctional alkoxysilanes as well as partial hydrolytic condensation products thereof; bis (trialkoxysilylalkyl)amines, bis (dialkoxyalkylsilylalkyl)amine, bis (trialkoxysilylalkyl)N-alkylamine, bis (dialkoxyalkylsilylalkyl) N-alkylamine, bis (trialkoxysilylalkyl)urea, bis (dialkoxyalkylsilylalkyl) urea, bis (3-trimethoxysilylpropyl)amine, bis (3-triethoxysilylpropyl)anine, bis (4-trimethoxysilylbutyl)amine, bis (4-triethoxysilylbutyl)amine, bis (3-trimethoxysilylpropyl)N-methylamine, bis (3-triethoxysilylpropyl)N-methylamine, bis (4-trimethoxysilylbutyl)N-methylamine, bis (4-triethoxysilylbutyl)N-methylamine, bis (3-trimethoxysilylpropyl)urea, bis (3-triethoxysilylpropyl)urea, bis (4-trimethoxysilylbutyl)urea, bis (4-triethoxysilylbutyl)urea, bis (3-dimethoxymethylsilylpropyl)amine, bis (3-diethoxymethyl silylpropyl)amine, bis (4-dimethoxymethylsilylbutyl)amine, bis (4-diethoxymethyl silylbutyl)amine, bis (3-dimethoxymethylsilylpropyl)N-methylamine, bis (3-diethoxymethyl silylpropyl)N-methylamine, bis (4-dimethoxymethylsilylbutyl)N-methylamine, bis (4-diethoxymethyl silylbutyl)N-methylamine, bis (3-dimethoxymethylsilylpropyl)urea, bis (3-diethoxymethyl silylpropyl)urea, bis (4-dimethoxymethylsilylbutyl)urea, bis (4-diethoxymethyl silylbutyl)urea, bis (3-dimethoxyethylsilylpropyl)amine, bis (3-diethoxyethyl silylpropyl)amine, bis (4-dimethoxyethylsilylbutyl)amine, bis (4-diethoxyethyl silylbutyl)amine, bis (3-dimethoxyethylsilylpropyl)N-methylamine, bis (3-diethoxyethyl silylpropyl)N-methylamine, bis (4-dimethoxyethylsilylbutyl)N-methylamine, bis (4-diethoxyethyl silylbutyl)N-methylamine, bis (3-dimethoxyethylsilylpropyl)urea bis (3-diethoxyethyl silylpropyl)urea, bis (4-dimethoxyethylsilylbutyl)urea and/or bis (4-diethoxyethyl silylbutyl)urea; bis (triethoxysilylpropyl)amine, bis (trimethoxysilylpropyl)amine, bis (trimethoxysilylpropyl)urea, bis (triethoxysilylpropyl)urea, bis (diethoxymethylsilylpropyl)N-methylamine; di or trialkoxy silyl terminated polydialkyl siloxane, di or trialkoxy silyl terminated polyarylalkyl siloxanes, di or trialkoxy silyl terminated polypropyleneoxide, polyurethane, polyacrylates; polyisobutylenes; di or triacetoxy silyl terminated polydialkyl; polyarylalkyl siloxane; di or trioximino silyl terminated polydialkyl; polyarylalkyl siloxane; di or triacetonoxy terminated polydialkyl or polyarylalkyl. The cross-linker (ii) used may also comprise any combination of two or more of the above.

The molar ratio of total silicon bonded hydroxyl groups to total hydrolysable groups is between 0.4:1 and 2:1 using a mono silyl containing cross linker or 0.5:1 to 4:1 using disilyl containing crosslinker. In one alternative the molar ratio of total silicon bonded hydroxyl groups to total hydrolysable groups is between 1:1 and 2:1.

The total hydrolysable groups molar content is calculated for 100 g of the mixed formulation. The molar content of hydrolysable groups related to a substance is equal to the amount in g of the molecule that contains the hydrolysable groups in 100 g of the mixed product divided by the molecular weight of the molecule or the number average molecular weight (Mn) in case it is a polymeric molecule multiply by the average number of hydrolysable functions present in the molecule. The sum of the molar content of each molecule or polymer is sum up to constitute the total molar content of hydrolysable groups in the formulation.

The molar ratio of total silicon bonded hydroxyl groups to total hydrolysable groups is then calculated by dividing the total molar content of total silicon bonded hydroxyl (Si—OH) groups by the total molar content of hydrolysable groups or can be depicted as a ratio.

The condensation curable self-sealing tyre silicone sealant composition further comprises a condensation catalyst. This increases the speed at which the composition cures. The catalyst chosen for inclusion in a particular condensation curable self-sealing tyre silicone sealant composition depends upon the speed of cure required.

Titanate and/or zirconate-based catalysts may comprise a compound according to the general formula Ti[OR²²]₄ or Zr[OR²²]₄ where each R²² may be the same or different and represents a monovalent, primary, secondary or tertiary aliphatic hydrocarbon group which may be linear or branched containing from 1 to 10 carbon atoms. Optionally the titanate and/or zirconate may contain partially unsaturated groups. Examples of R²² include but are not restricted to methyl, ethyl, propyl, isopropyl, butyl, tertiary butyl and a branched secondary alkyl group such as 2,4-dimethyl-3-pentyl. Alternatively, when each R²² is the same, R²² is an isopropyl, branched secondary alkyl group or a tertiary alkyl group, in particular, tertiary butyl. Suitable titanate examples include tetra n-butyl titanate, tetra t-butyl titanate, titanium tetrabutoxide and tetraisopropyl titanate. Suitable zirconate examples include tetra-n-propyl zirconate, tetra-n-butyl zirconate and zirconium diethylcitrate.

Alternatively, the titanate and/or zirconate may be chelated. The chelation may be with any suitable chelating agent such as an alkyl acetylacetonate such as methyl or ethylacetylacetonate.

Alternatively, the titanate may be monoalkoxy titanates bearing three chelating agents such as for example 2-propanolato, tris isooctadecanoato titanate or diisopropyldiethylacetoacetate titanate.

The molar ratio of catalyst M-OR functions to the sum of moisture present in the composition, as determined in accordance with ISO 787-2:1981 and total silicon bonded hydroxyl groups is between 0.01:1 and 0.6:1, where M is titanium or zirconium.

The condensation curable self-sealing tyre silicone sealant composition as hereinbefore described is typically made from the condensation curable gel or elastomer composition which is stored in a 2-part manner. The two-part compositions may be mixed using any appropriate standard two-part mixing equipment with a dynamic or static mixer and is optionally dispensed therefrom for use in the application for which it is intended.

In one embodiment, the two-part condensation curable self-sealing tyre silicone sealant composition is stored in two parts where said parts may be divided as follows
a) polymer (i) and cross-linker (ii) in one part and polymer (i) and catalyst (iii) in the other part;
b) cross-linker (ii) in one part and polymer (i) and catalyst (iii) in the other part or
c) when more than one polymer (i) is being utilised a first polymer (i) and cross-linker (ii) in one part and a second polymer (i) and catalyst (iii) in the other part;
d) polymer (i) in one part and the cross-linker (ii) and catalyst (iii) in the other part.

In each case the filler and catalyst are not in the same part. Typically, when present, filler is mixed with polymer (i) in a base part which may also contain other additives.

The two parts can be mixed in any suitable ratio, e.g., base part:catalyst package for example from 15:1 to 1:1, alternatively 10:1 to 1:1, alternatively 5:1 to 1:1, preferably 1:1.

### Optional Ingredients

Other than the above components optional components may be blended in the condensation curable self-sealing tyre silicone sealant composition within suitable ranges.

Examples of optional components include fillers, heat resistance-imparting agents, cold resistance-imparting agents, flame retarders, thixotropy-imparting agents, pigments, surfactants, flux agents, acid acceptors, protection agents, UV stabilizers, antioxidants, antiozonants, anti-corrosion additives, dyes and any suitable combination thereof.

### Fillers

The two-part condensation curable self-sealing tyre silicone sealant composition may incorporate fillers, for example reinforcing and/or non reinforcing inorganic fillers, thermally and/or electrically conductive fillers e.g., metallic fillers and meltable fillers, or a combination thereof.

Examples of finely divided, reinforcing fillers include high surface area fumed and precipitated silicas including rice hull ash and to a degree calcium carbonate. Examples of additional finely divided non-reinforcing fillers include crushed quartz, diatomaceous earths, barium sulphate, iron oxide, titanium dioxide, carbon black, glass beads, hollow glass beads, talc, wollastonite. Other fillers which might be used alone or in addition to the above include carbon nanotubes, e.g., multiwall carbon nanotubes, carbon fibres, aluminite, calcium sulphate (anhydrite), gypsum, calcium sulphate, barium titanate, magnesium carbonate, clays such as kaolin, aluminium trihydroxide, magnesium hydroxide (brucite), graphite, diamond, copper carbonate, e.g., malachite, nickel carbonate, e.g., zarachite, barium carbonate, e.g., witherite and/or strontium carbonate e.g., strontianite. Examples of anhydrous inorganic fillers include onyx; aluminium trihydrate, metal oxides such as aluminium oxide, beryllium oxide, magnesium oxide, zinc oxide; nitrides such as aluminium nitride and boron nitride; carbides such as silicon carbide and tungsten carbide; and combinations thereof.

Further examples of fillers include aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃·2SiO₂; kyanite; and Al₂SiO₅. The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃]. The sheet silicates group comprises silicate minerals, such as but not limited to, mica; K₂AI₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; Al₄[Si₄O₁₀](OH)s; and vermiculite.

Any combination of two or more of the above fillers may be used.

When present in a preferred embodiment the fillers utilised are selected from fumed and precipitated silicas, calcium carbonate, carbon black, hollow glass beads and/or carbon nanotubes, e.g., multiwall carbon nanotubes, and mixtures thereof.

### Filler Treating Agent

The conductive fillers and/or the anhydrous reinforcing and/or extending filler if present, may optionally be surface treated with a treating agent. Treating agents and treating methods are known in the art, The surface treatment of the filler(s) is typically performed, for example with a fatty acid or a fatty acid ester such as a stearate, or with organosilanes, organosiloxanes, or organosilazanes such as hexaalkyl disilazane or short chain siloxane diols. Generally, the surface treatment renders the filler(s) hydrophobic and therefore easier to handle and obtain a homogeneous mixture with the other components in the composition. Silanes such as

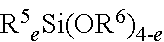

wherein R⁵ is a substituted or unsubstituted monovalent hydrocarbon group of 6 to 20 carbon atoms, for example, alkyl groups such as hexyl, octyl, dodecyl, tetradecyl, hexadecyl, and octadecyl, and aralkyl groups such as benzyl and phenylethyl, with the alkyl groups of 6 to 20 carbon atoms being preferred, R⁶ is an alkyl group of 1 to 6 carbon atoms, and letter e is equal to 1, 2 or 3 may also be utilised as the treating agent for fillers.

### Adhesion Promoter

Suitable adhesion promoters may comprise alkoxysilanes of the formula R¹⁴ₕSi(OR¹⁵)₍₄₋ₕ₎, where subscript h is 1, 2, or 3, alternatively h is 3. Each R¹⁴ is independently a monovalent organofunctional group. R¹⁴ can be an epoxy functional group such as glycidoxypropyl or (epoxycyclohexyl)ethyl, an amino functional group such as aminoethylaminopropyl or aminopropyl, a methacryloxypropyl, a mercapto functional group such as mercaptopropyl or an unsaturated organic group. Each R¹⁵ is independently an unsubstituted, saturated hydrocarbon group of at least 1 carbon atom. R¹⁵ may have 1 to 4 carbon atoms, alternatively 1 to 2 carbon atoms. R¹⁵ is exemplified by methyl, ethyl, n-propyl, and iso-propyl.

Examples of suitable adhesion promoters include glycidoxypropyltrimethoxysilane and a combination of glycidoxypropyltrimethoxysilane with an aluminium chelate or zirconium chelate.

Examples of adhesion promoters may be found in U.S. Pat. Nos. 4,087,585 and 5,194,649.

The condensation curable self-scaling tyre silicone sealant composition may comprise, when present, 0.01% to 2 wt. %, alternatively 0.05 to 2 wt. %, alternatively 0.1 to 1 wt. % of adhesion promoter based on the weight of the composition. Preferably, the speed of hydrolysis of the adhesion promoter should be lower than the speed of hydrolysis of the cross-linker in order to favour diffusion of the molecule towards the substrate rather than its incorporation in the product network.

The two-part composition is mixed in a suitable mixing/dosing unit and the mixed composition is immediately applied onto the target substrate (tyre) surface. Post mixing the composition is designed to have sufficient green strength to adhere to the tyre inner surface and will cure after several hours.

Typically, the two-part condensation curable self-sealing tyre silicone sealant composition is applied in an uncured state and cures upon mixing and deposition on the substrate tyre surface so as to have a cured thickness of between 0.25 and 10 mm, alternatively between 0.5 mm and 10 mm, alternatively between 1 and 5 mm, depending on the end use as discussed below. Subsequent to intermixing but prior to cure the condensation curable self-sealing tyre silicone sealant composition may be applied on to a substrate using a suitable dispenser such as for example curtain coaters, spray devices die coaters, dip coaters, extrusion coaters, knife coaters and screen coaters which upon cure formation is provides a coating on said substrate.

The thickness and pressure requirements required will vary depending on the end use of the tyre concerned. Thus, for example, for tyres of passenger vehicle type, it can have a thickness of at least 0.5 mm, preferably between 1 and 5 mm. According to another example, for tyres for heavy duty or agricultural vehicles, the preferred thickness can lie between 1 and 6 mm. According to another example, for tyres for vehicles in the field of earthmoving equipment or for aircraft, the preferred thickness can lie between 2 and 10 mm. Finally, according to another example, for bicycle tyres, the preferred thickness can lie between 0.4 and 2 mm.

The condensation cured self-sealing silicone sealant derived from the two-part condensation curable self-sealing tyre silicone sealant composition described above is a tacky solid (at 23° C.) and is characterized in particular, thanks to its specific formulation, by a very high flexibility and deformability. One advantage of use of the composition as described herein is that the cured layer has the advantage of exhibiting, within a very wide range of operating temperatures for the tyres, virtually no disadvantage in terms of rolling resistance in comparison with a tyre not comprising a self-sealing layer. In comparison with non-silicone self-sealing compositions, the risks of excessive creep during use at relatively high temperature (typically greater than 60° C.), a temperature frequently encountered during the use of some tyres, are notably reduced as silicone-based materials are more resistant to extreme temperature changes than many organic alternatives. Its self-sealing properties are also improved during use at low temperature (typically less than 0° C.).

Furthermore, the condensation cured self-sealing silicone sealant derived from the aforementioned condensation curable self-sealing tyre silicone sealant composition has a storage modulus of between 9,000 and 26,000 Pa. A storage modulus comprised between these two values has been identified to provide the right balance between softness (tackiness to the nail or itself) and hardness (creep/flow resistance under pressure). A silicone formulation exhibiting such a storage modulus at 23° C. will exhibit a storage modulus at other temperatures, i.e., from −25 to 100° C., which still is compliant with the required balance of modulus to act as a self-sealing coating for tyres.

If a foreign body, such as a nail, passes through the structure of the tyre, the sealant serving as self-sealing layer is subjected to several stresses. In reaction to these stresses, and thanks to its advantageous deformability and elasticity properties, said sealant creates an impermeable contact zone around the body. It does not matter whether the contour or the profile of said body is uniform or regular, the flexibility of the self-sealing sealant enables it to be insinuated into openings of very small size. This interaction between the self-sealing composition and the foreign body seals the zone affected by said body.

In the event of the foreign body being removed, whether accidentally or intentionally, a perforation remains, this being liable to create a relatively large leak, depending on its size. The condensation curable self-sealing tyre silicone sealant composition, exposed to the hydrostatic pressure, is sufficiently soft and deformable to seal off, by being deformed, the perforation, preventing the inflation gas from leaking. In particular in the case of a tyre, it has been shown that the flexibility of the self-sealing sealant enables the forces of the surrounding walls to be withstood without any problems, even during phases in which the loaded tyre deforms when running/rolling. used again on vehicles.

Once recycled the SST rubber tyre body may be utilised as a means of shock absorption, sound absorption, non-slip, insulting and abrasion and crack resistant applications. For example, it may be used in construction materials, e.g., for resurfacing playgrounds and artificial sports fields, can be used in in road surfacing materials e.g., as ground and crumb rubber for rubberized asphalt, or in aggregate and or concrete but can also be incorporated in anti-slip mats and other carpet mats, shock cushioning in shock absorbing applications.

Gases, liquids and solid ashes can result from pyrolysis. The gases may be used e.g., as fuels, the liquid may also be utilised for fuel and the solid material, being carbon based can be used as a source for e.g., carbon black and carbon electrodes.

As previously indicated the recycled condensation cured self-sealing silicone sealant may be utilised as siloxane oligomers which can be reused to make siloxane polymers.

### FIGURES

There follows a brief description of the figures in which:

FIG. 1a depicts illustrates a first means for continuously removing condensation cured self-sealing silicone sealant from the inner face of a tyre body by a scraping process as described above.

FIG. 1b depicts illustrates a first means for continuously removing condensation cured self-sealing silicone sealant from the inner face of a tyre body by a peeling process as described above.

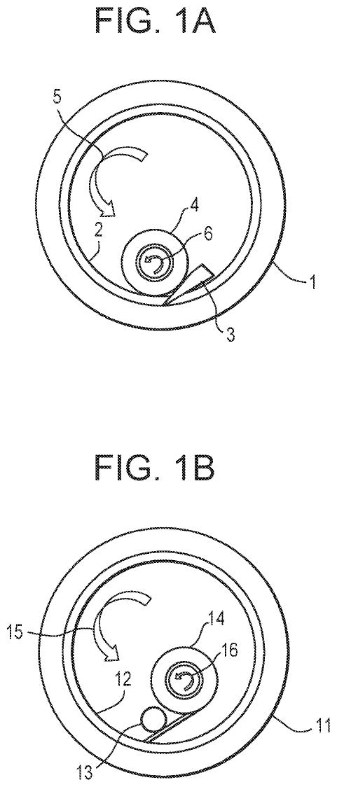

In the case of the scraping and peeling concepts depicted in FIGS. 1a and 1b respectively the whole tyre may be rotated via a tyre spreader (not shown) such as a 5700 Tyre Spreader from Branick Industries Inc. of North Dakota USA

In FIG. 1a, the scraping embodiment, there is provided a self-sealing tyre (1) on which is a silicone self-sealing tyre condensation cured sealant layer (2). A scraper (3) is utilised to scrape the silicone self-sealing tyre condensation cured sealant layer (2) from the self-sealing tyre (1) and a roller (4) for collecting the scraped off sealant layer (2). In FIG. 1a the self-sealing tyre (1) is designed to rotate in an anti-clockwise motion (5) and roller (4) is also designed to rotate in the same (anti-clockwise) direction (6). In use, the self-sealing tyre (1) is rotated anti-clockwise (5) and scraper (3) separates the sealant layer (2) from the self-sealing tyre (1) by scraping the sealant layer (2) from the self-sealing tyre (1). The scraper (3) is shaped so as to aid in the transfer of separated sealant onto roller (4). Once the sealant layer (2) has been removed and is all on roller (4), it may be removed from roller (4) and then further processed as desired.

In FIG. 1b, the peeling embodiment, there is provided a self-sealing tyre (11) on which is a silicone self-sealing tyre condensation cured sealant layer (12). A roller (or plate) (13) is utilised for controlling the peel angle of self-sealing tyre condensation cured sealant layer (12) being removed from the self-sealing tyre (11). A roller (or mandrel) (14) is used for continuously collecting the peeled sealant layer (12). In FIG. 1b the self-sealing tyre (11) is designed to rotate in an anti-clockwise motion (15) and roller (14) is designed to rotate in the same (anti-clockwise) direction (16). In use, a cut is made in the layer of condensation cured self-sealing silicone sealant (12), to form a first and second end thereof. The first end of condensation cured self-sealing silicone sealant (12) is attached to roller (14) and the said condensation cured self-sealing silicone sealant is removed by peeling it from the tyre (11) with the self-sealing tyre (11) being rotated anti-clockwise (15) and the sealant layer (12) is peeled from the self-sealing tyre (11) and is transferred onto roller (14). Once the sealant layer (12) has been removed and is all on roller (14), it may be removed from roller (14) and then further processed as desired.

### EXAMPLES

All examples that follow used a commercially available silicone self-sealing tyre condensation curable sealant, SILASTIC™ SST-2650 from Dow Silicones Corporation. It is a two-part condensation curable self-sealing tyre silicone sealant composition and in each example depicted below was mixed, applied and cured in accordance with the commercial instructions for the composition. It was applied onto the inner surface of a portion (15.5 cm×15.5 cm) of an end-of-life rubber tyre. Samples were used from multiple manufacturers and it was considered the results on tyre from different sources were consistent.

In the examples described below testing was undertaken on the following equipment (unless otherwise indicated). The SST sealant recycling apparatus comprises the following:
a 5700 Tyre Spreader from Branick Industries Inc. of North Dakota USA tyre spreader in combination with a motor for rotating the SST while sealant is being removed by scraping or peeling;
For scraper experiments, a 6-piece pneumatic scraper kit type 95826 obtained from harbourfreight.com was used. In the experimental work no additional non-stick coating or lubricant was applied on its surfaces;
Suitable rollers for collecting the separated sealant material for both scraping and peeling experiments were utilised to collect removed sealant.

Whilst an element such as a roller or plate may be used for controlling the peeling angle in the peeling configuration for the examples herein the sealant collecting element was a suitable roller set up to function at a selected peeling angle such that in the case of the peeling process, the tyre rotates and collects the peeled sealant as it is peeled off the inner surface of the tyre body with the roller fixed in position so that the sealant is peeled at a fixed peeling angle relative to the inner surface of the tyre when horizontal, whilst the tyre rotates enabling the sealant to be removed.

In a first pair of examples manual scraping was compared to using a pneumatic scraper. The following process depicts the testing undertaken after the SILASTIC™ SST-2650 had cured on the surface of the inner face of the tyre rubber body test-piece.

Process steps for using a scraper
a) The cured sealant was precut across the whole width of the tyre sample using the pneumatic scraper after which the scraper was positioned in an initial position after which scraping was initiated;
b) An edge of the cut sealant was lifted and attach to a roller so that the sealant will adhere to the roller;
c) The scraper was then used to scrape off the sealant at a set angle to the tyre sample used and the process was compared using a manual scraper and a 6-piece pneumatic scraper kit type 95826 obtained from harbourfreight.com;
d) The sealant was scraped off the inner surface of each sample of tyre body whilst simultaneously a suitable roller was rotated at a suitable speed to continuously collect the removed sealant. It was found that the adhesive nature of the cured SILASTIC™ SST-2650 sealant enabled the newly collected sealant to stick to the already collected sealant at the interfacial surfaces, which assisted in the collecting operation; and
e) The sealant was removed from the tyre samples in one scraping activity simulating a complete rotation of the whole tyre.

It was found that the sealant was easily removed using both scrapers but the pneumatic scraper was preferred as the agitation helped separate the sealant from the inner surface of the sample of tyre body more easily.

A series of examples were run using the pneumatic scraper, measuring the time taken to remove the sealant (SILASTIC™ SST-2650), from the inner surface of the sample of tyre body. The results are depicted in Table 1 below.

TABLE 1
Silicone sealant (SILASTIC ™ SST-2650) scraping
experiments using a pneumatic scraper

| Scraping | Time | Length | Speed |
|---|---|---|---|
| Trials (#) | (s) | (mm) | (mm/s) |
| 1 | 6.61 | 155 | 23.4 |
| 2 | 6.07 | 155 | 25.5 |
| 3 | 3.73 | 155 | 41.6 |
| 4 | 2.51 | 155 | 61.8 |
| 5 | 2.11 | 155 | 73.5 |
| 6 | 1.88 | 155 | 82.4 |
| 7 | 1.79 | 155 | 86.6 |
| 8 | 1.68 | 155 | 92.3 |

As can be seen, the speed increases with the increase in the trial # as the operator gets more familiar and more efficient using the pneumatic scraper. These experiments demonstrated that a sealant removal speed of greater than 92 mm/s can be achieved using a hand-operated pneumatic scraper.

### Sealant Removal Rate

The proportion of sealant removed (removal rate) with respect to scraping trials #7 and #8 from Table 1 were determined. Table 2 lists the sealant mass of removed and remained (residual) on the samples measured for the last two scraping trials #7 and #8.

TABLE 2
Silicone sealant (SILASTIC ™ SST-2650) removal Rate

| Scraping | Sealant | Sealant | Removal |
|---|---|---|---|
| Trials (#) | Removed (g) | Residual (g) | rate |
| 7 | 13.8 | 1.0 | 93.2% |
| 8 | 18.2 | 0.4 | 97.6% |

| | |
|---|---|
| Average | 95.4% |

It can be seen that despite the speed of removal over 90% of the silicone sealant had been removed, indeed an average of greater than 95%.

### Sealant Scraping Force at Varied Temperatures

Sealant scraping forces were measured using a Nextech DFS-X1000 (1000N/2201bf/100 kgf) Digital Force Gauge which had an External S-Beam Load Cell, Peak/Track Mode, Pass/Fail LED, USB Output and a Back-Lit Graphic LCD, Metal Enclosure obtained from Amazon.com.

The Nextech DFS-X1000 was connected to a scraper of 45.1 mm in width. The sealant scraping forces were measured by connecting a scraper to Nextech DFS-X1000 using an adapter, which was connected to a set of pushing handles on the other end (vs the end connected to the scraper). The operator manually pushed the handles, the load cell recorded the force exerted to the scraper. The maximum force recorded by the Nextech DFS-X1000 during the scraping process of a sample was identified as the scraping force and is indicated in Tables 3, 4 and 5 below. The scraping force per unit length was calculated by dividing the scraping force by the width of the scraper in mm i.e., for the examples herein a width of 45.1 mm as indicated above.

The scraping angle was kept at 30°. The scraping angle (defined as the angle between the surface on the tyle substrate from which the sealant is being removed and the plane of the scraper blade) was monitored and maintained during the scraping process using a magnetic protractor attached to the upper surface of the scraper. The tyre body samples used for the examples were samples of tyres coated with SILASTIC™ SST-2650 sealant. In addition to measurements at room temperature (22° C.), measurements were also performed on samples held in environmental chambers for at least 4 hours set at −20° C. and 70° C., respectively to ensure that the temperature with the samples reaches an equilibrium at the target temperature. The samples other than at room temperature were removed one at a time from the environmental chambers and the scraping force measurements were then undertaken in the laboratory at room temperature recording the force value.

Table 3, Table 4 and Table 5 list the measured scraping forces at, room temperature (22° C.), −20° C., and 70° C., respectively.

TABLE 3
SILASTIC ™ SST-2650 sealant scraping
force measurements at room temperature

| | Scraping | Scraping Force per |
|---|---|---|
| Measurements # | Force (N) | unit length (N/mm) |
| 1 | 35.8 | 0.8 |
| 2 | 36.8 | 0.8 |
| 3 | 32.4 | 0.7 |
| Average | 35.0 | 0.8 |
| Standard Dev | 3.0 | 0.1 |

TABLE 4
SILASTIC ™ SST-2650 sealant scraping force
measurements at −20° C.

| | Scraping | Scraping Force per |
|---|---|---|
| Measurements # | Force (N) | unit length (N/mm) |
| 1 | 45.6 | 1.0 |
| 2 | 41.4 | 0.9 |
| 3 | 39.6 | 0.9 |
| Average | 42.2 | 0.9 |
| Standard Dev | 3.1 | 0.1 |

TABLE 5
SILASTIC ™ SST-2650 sealant scraping
force measurements at 70° C.

| | Scraping | Scraping Force per |
|---|---|---|
| Measurements # | Force (N) | unit length (N/mm) |
| 1 | 27.6 | 0.6 |
| 2 | 32.0 | 0.7 |
| 3 | 33.8 | 0.7 |
| Average | 31.1 | 0.7 |
| Standard Dev | 3.2 | 0.1 |

It can be seen that the measured scraping forces at the three temperatures, can be compared and it is observed that the scraping force decreases as temperature increases. In the case of SILASTIC™ SST-2650, all the measured linear scraping forces (calculated as total force divided by the scraper width) are less than 1.0 N/mm.

### Peeling Experiments

Measurements of the peeling force on tyre samples coated with SILASTIC™ SST-2650 sealant were attempted with the Nextech DFS-X1000 in conjunction with a clamp of 55.0 mm in width.

It was found that whilst the sealant was removeable by peeling it was more difficult to obtain complete removal in a single rotation of the tyre because of the level of adhesion between the sealant and the inner surface of the tyre body. During the removal process the cured sealant was prone to tensile failure before being peeled off completely from the tyre substrate in some of the experiments conducted. The peeling is more likely to be used for les adhesive and higher tensile strength sealants used for SSTs.

### Peeling Angle Impact

The impact of the peeling angle utilised for peeling off the sealant from the inner surface of the tyre body was studied using acute, right, and obtuse angles. The study showed that sealant is more prone to tensile breakage at an obtuse angle (i.e., an angle of greater than 90° but no more than 180°) and acute angles were more user-friendly for peeling.

### Peeling Temperature Impact

Peeling tests were performed on samples having been held for more than 4 hours in environmental chambers set at −20° C. and 70° C., respectively. The preparation process for testing was the same as for the temperature testing of the scraping process. The study revealed that sealant peels off the tyre samples easier at 70° C. than −20° C. and room temperature, which is consistent with the scraping force measurements above.

It was considered that the peeling option does function successfully as a means of removing the sealant from the inner surface of the tyre body there is a greater tendency for the cured sealant to tear during removal and as such the scraping option was found to be preferable.

### Comparative Example

Attempts were made to remove butyl/synthetic rubber blend sealants via both peeling and scraping methods. It was found that it is impractical to remove butyl/synthetic rubber blend sealants via conventional peeling or scraping methods.

1. A method of recycling one or more self-sealing tyres, the or each self-sealing tyre having a tyre body made of a flexible and airtight material and optionally containing one or more reinforcing wires, reinforcing fibres or both made from one or more of metals, polymers, and/or glass, the tyre body having an inner surface and an outer surface and a puncture-resistant layer applied on the inner surface, wherein the puncture-resistant layer is a layer of a condensation cured self-sealing silicone sealant, the method comprising the steps of:
ai) removing the layer of condensation cured self-sealing silicone sealant by scraping it off the inner surface of the tyre body with a scraper, or
aii) making a cut in the layer of condensation cured self-sealing silicone sealant, to form a first and second end thereof, attaching the first end of the layer of condensation cured self-sealing silicone sealant to a roller and removing the condensation cured self-sealing silicone sealant by peeling it from the inner surface of the tyre body;
b) optionally, removing reinforcing wires, reinforcing fibres or both made from one or more of metals, polymers, and/or glass from the tyre body;
c) recycling the tyre body resulting from step (ai), step (aii), or step (b) by shredding, grinding, cryogenic crushing, pyrolysis, and/or microwave techniques; and
d) recycling or reusing the condensation cured self-sealing silicone sealant removed in step (ai) or step (aii).

2. The method of recycling one or more self-sealing tyres in accordance with claim 1, wherein in step (ai) the scraper is electrically, pneumatically, hydraulically, or acoustically operated.

3. The method of recycling one or more self-sealing tyres in accordance with claim 1, wherein step ai) is sub-divided into the following process steps:
a) placing a self-sealing tyre containing a puncture-resistant layer of condensation cured self-sealing silicone sealant on a support which allows a tyre and scraper to be rotated relative to each other;
b) precutting the condensation cured self-sealing silicone sealant across the whole or part of the width of the inner surface of the tyre using a scraper or knife to provide a first cut end in the condensation cured self-sealing silicone sealant and a second cut end in the condensation cured self-sealing silicone sealant and positioning the scraper between the first cut end and the second cut end in the condensation cured self-sealing silicone sealant;
c) initiating scraping by inserting the scraper between the first cut end in the condensation cured self-sealing silicone sealant and the tyre body inner surface, with the scraper positioned at a suitable scraping angle relative to the tyre body inner surface to cause an initial separation of condensation cured self-sealing silicone sealant from the tyre body inner surface and initiating operation of a means for collecting condensation cured self-sealing silicone sealant as it becomes separated from the inner surface of the tyre body;
d) either rotating the tyre relative to the scraper being in a fixed position or rotating the scraper around the inner surface of the tyre body when the tyre is in a fixed position to continuously separate the condensation cured self-sealing silicone sealant from the inner surface of the tyre body and collecting the condensation cured self-sealing silicone sealant as it is removed;
e) in the case where only part of the width of the layer of sealant on the inner surface of the tyre was cut and removed in steps b), c) and d), repeating steps b), c), and d) for one or more further parts until the condensation cured self-sealing silicone sealant has been totally removed; and
f) once the condensation cured self-sealing silicone sealant is removed from the self-sealing tyre to leave a substantially sealant-free tyre body, removing the tyre body from the support and the collected condensation cured self-sealing silicone sealant for further processing.

4. The method of recycling one or more self-sealing tyres in accordance with claim 1, wherein step aii) is sub-divided into the following process steps:
a) placing a self-sealing tyre containing a puncture-resistant layer of condensation cured self-sealing silicone sealant on a support which allows a tyre to be rotated;
b) precutting the condensation cured self-sealing silicone sealant across the whole tyre width using a scraper or knife to provide a first cut end in the condensation cured self-sealing silicone sealant and a second cut end in the condensation cured self-sealing silicone sealant and connecting the first cut end to a roller/mandrel/screw designed to collect the condensation cured self-sealing silicone sealant subsequent to having been peeled from the inner surface of the tyre body;
c) initiating peeling of the condensation cured self-sealing silicone sealant from the inner surface of the tyre body by rotating the tyre relative to the roller/mandrel/screw enabling the peeled sealant to be collected on the roller/mandrel/screw with the roller/mandrel/screw positioned at a suitable peeling angle and distance from the condensation cured self-sealing silicone sealant being peeled from the inner surface of the tyre body;
d) rotating the tyre relative to the roller/mandrel/screw at a desired peeling angle controlling roller to adjust the peeling angle in a desired range, optionally an acute angle, thereby continuously peeling the condensation cured self-sealing silicone sealant from the inner surface of the tyre body and collecting the condensation cured self-sealing silicone sealant as it is removed while simultaneously rotating the condensation cured self-sealing silicone sealant collecting roller/mandrel/screw to continuously peel and collect the removed sealant; and
(e) once the condensation cured self-sealing silicone sealant is removed from the self-sealing tyre to leave a substantially sealant-free tyre body, removing the tyre body from the support and the collected condensation cured self-sealing silicone sealant for further processing.

5. The method of recycling one or more self-sealing tyres in accordance with claim 4, wherein in step (aii) the condensation cured self-sealing silicone sealant is peeled off at an acute angle.

6. The method of recycling one or more self-sealing tyres in accordance with claim 4, wherein in step (aii) a second roller is utilised as a means of controlling the peeling angle.

7. The method of recycling one or more self-sealing tyres in accordance with claim 1, wherein on average a minimum of 80% by weight of the condensation cured self-sealing silicone sealant is removed from the inner surface of the tyre.

8. The method of recycling one or more self-sealing tyres in accordance with claim 7, wherein on average a minimum of 90% by weight of the condensation cured self-sealing silicone sealant is removed from the inner surface of the tyre.

9. The method of recycling one or more self-sealing tyres in accordance with claim 7, wherein the condensation cured self-sealing silicone sealant which is removed from the inner surface of the tyre is obtained in a single operation.

10. The method of recycling one or more self-sealing tyres in accordance with claim 1, wherein in step (ai) or step (aii), after removing the condensation cured self-sealing silicone sealant, the removed sealant is collected on a roller, a mandrel or by vacuum means.

11. The method of recycling one or more self-sealing tyres in accordance claim 1, wherein the condensation cured self-sealing silicone sealant removed in step (ai) or step (aii) is recycled by depolymerization, pyrolysis, and/or mechanically.

12. The method of recycling one or more self-sealing tyres in accordance claim 1, wherein the puncture-resistant layer of condensation cured self-sealing silicone sealant has a thickness of greater than 0.3 mm.

13. The method of recycling one or more self-sealing tyres in accordance with claim 12, wherein the puncture-resistant layer of condensation cured self-sealing silicone sealant has a thickness of between 0.5 mm and 10 mm.

14. The method of recycling one or more self-sealing tyres in accordance with claim 1, wherein the condensation cured self-sealing silicone sealant is the cured product of a condensation curable self-sealing tyre silicone sealant composition comprising:
(i) at least one condensation curable silyl terminated polymer having at least one, optionally at least two, hydroxyl functional groups per molecule;
(ii) a cross-linker selected from the group of
silanes having at least two 2-hydrolysable groups, optionally at least three hydrolysable groups per molecule group; and/or
silyl functional molecules having at least two silyl groups, each silyl group containing at least one hydrolysable group; and
(iii) a condensation catalyst selected from the group of titanates and/or zirconates;
wherein the titanates and zirconates comprise M-OR functions where M is titanium or zirconium, and R is an aliphatic hydrocarbon group;
wherein (i), (ii), and (iii) are not stored together in a single part;
wherein the molar ratio of total silicon bonded-hydroxyl groups to total hydrolysable groups is between 0.5:1 and 2:1 using a silane containing cross linker or 0.5:1 to 10:1 using silyl functional molecules containing crosslinker; and
wherein the molar ratio of M-OR functions to the sum of moisture present in the composition, as determined in accordance with ISO 787-2:1981, and total silicon bonded hydroxyl groups is between 0.01:1 and 0.6:1.

15. Recycled rubber and recycled silicone sealant obtained as products of the method of claim 1 from a self-sealing tyre.
